(19) United States
(12) Patent Application Publication
(10) Pub. No.: US 2003/0107658 A1
(43) Pub. Date: Jun. 12, 2003

(54) Apparatus and method for image capture

(76) Inventors: Chien-Chang Huang, Hsinchu (TW); Jeng-Feng Lan, Hsinchu (TW); Chun-Huang Lin, Hsinchu (TW)

Correspondence Address: FRANK R. OCCHIUTI, Fish & Richardson P.C., 225 Franklin Street, Boston, MA, 02110-2804, US

(21) Appl. No.: 10/313,212

(22) Filed: Dec. 6, 2002

(30) Foreign Application Priority Data
Dec. 11, 2001 (TW) 090130702

(51) Int. Cl. H04N 9/68

(52) U.S. Cl. 348/221.1; 348/229.1; 348/234

(57) ABSTRACT

An apparatus for capturing an image to generate pixel data thereof. The apparatus comprises a sensor having pixel lines sequentially reset to be exposed by reflection from the image for a period of time, wherein all the exposure time periods of pixel lines overlap, a light source illuminates the image, whereby the image is reflected to the sensor, and a controller turns on the light source during the overlapping interval of the exposure time periods of pixel lines.

### BACKGROUND OF THE INVENTION

1. Field of the Invention

The present invention relates to image capture and particularly to an apparatus and method for simultaneously acquiring all pixel data of an image using a progressive scan sensor.

2. Description of the Related Art

FIG. 1 is a diagram showing a conventional image capture device. It includes an exposure controller 11, a sensor array 12 and a light source 13. The exposure controller 11 has a column counter 111 and a line counter 112. The sensor array 12 is composed of lines and columns of pixels (not shown). The pixels accumulate charges therein when being exposed. The light source 13 illuminates a target image, whereby the image is reflected to the sensor array 12.

The operation of the image capture device is explained in the following. The sensor array 12 has, for example, 16 pixel lines 0˜15. The exposure controller 11 sequentially outputs readout signals R0˜R15 and reset signals R0_reset˜R15_reset to the sensor array 12. The charges previously accumulated in the pixels of a line to which a logic-high reset signal is applied are released, whereby the reset pixel line is refreshed to accumulate charges for the next frame. The voltages formed by the accumulated charges in the pixels of a line to which a logic-high readout signal is applied are output as pixel data. Thus, all the pixel data of each frame is progressively acquired line by line.

FIG. 2 is a diagram showing the timing of the readout and reset signals. The reset signal R0_reset is pulled up to a logic high level to reset the pixels of line 0 in the sensor array 12 and the readout signal R0 is also pulled up to the logic high level to read out the data in pixel line 0 after it has been exposed for one exposure time t1. Following the reset of pixel line 0, the reset signal R1_reset is pulled up to the logic high level to reset the pixels of line 1 and the readout signal R1 is also pulled up to the logic high level to read out the data in pixel line 1 after it has been exposed for one exposure time t1. The pixels and data of lines 2˜15 are reset and read out in the same way. The pulling up of the reset signals R0_reset˜Rl5_reset (i.e., the reset of pixel line 0˜15) follows the counting of line counter 112 and the lengths of the time intervals therebetween are the same.

The frequency of the pulses generated in each readout signals is the frame rate and the period T between the pulses is the frame time. The frame rate or time is controlled by line counter 112 in the exposure controller 11. Line counter 112 counts from an initial value (0) to a final value (15). When the counting reaches the final value, it is reset to the initial value. The frame time is one cycle time of the counting.

In the conventional image capture device, it is noted from FIG. 2 that since the frame time T equals the cycle time of line counter 112, the exposure time t1 must be shorter than the frame time T. If not, each of pixel lines is reset prior to be readout. Additionally, the exposure period of pixel line 15 begins one frame time later than that of pixel line 0. The exposure period of pixel line 0 must end before that of pixel line 15 starts. Consequently, it is impossible for exposure periods of pixel lines 0 and 15 to overlap.

The non-overlapping of the exposure periods of pixel line 0 and 15 results in acquisition of some of the pixel data in each frame in two separate periods. This causes image distortion, especially in an image capture device with a low frame rate.

### SUMMARY OF THE INVENTION

The object of the present invention is to provide an apparatus and method for simultaneously acquiring all pixel data of an image using a progressive scan sensor.

The present invention provides an apparatus for capturing an image to generate pixel data thereof. The apparatus comprises a sensor having pixel lines sequentially reset to be exposed by reflection from the image for a period of time, wherein all the exposure time periods of pixel lines overlap, a light source illuminates the image, whereby the image is reflected to the sensor, and a controller turns on the light source during the overlapping interval of the exposure time periods of pixel lines.

The present invention further provides a method for capturing an image to generate pixel data thereof. The method comprises providing a light source and a sensor having pixel lines, sequentially resetting pixel lines for exposure by reflection from the image for a period of time, wherein all the exposure time periods of pixel lines overlap, and turning on the light source during the overlapping interval of the exposure time periods of pixel lines to illuminate the image, whereby the image is reflected to the sensor.

Thus, in the present invention, line counter counts to a number larger than the number of pixel lines, whereby the cycle time of the counter is prolonged. Instead of being reset immediately after the reset of the last pixel line, the first pixel line is not reset until the counter is reset. That is to say, after the last pixel line is reset, the counter keeps counting but no pixel line follows the counting to be reset until it reaches the final value. This eliminates the limitation in the conventional image capture device in which the exposure periods of the first and last pixel lines do not overlap.

### BRIEF DESCRIPTION OF THE DRAWINGS

The preferred embodiment of the invention is hereinafter described with reference to the accompanying drawings in which:

FIG. 1 is a diagram showing a conventional image capture device.

FIG. 2 is a diagram showing the timing of the signals used in the conventional image capture device.

FIG. 3 is a diagram showing the timing of the signals used in an image capture device according to one embodiment of the invention.

FIG. 4 is a diagram showing a light source used in an image capture device according to one embodiment of the invention.

FIG. 5 is a diagram showing another light source used in an image capture device according to one embodiment of the invention.

FIG. 6 is a diagram showing a method for image capture according to one embodiment of the invention.

### DETAILED DESCRIPTION OF THE INVENTION

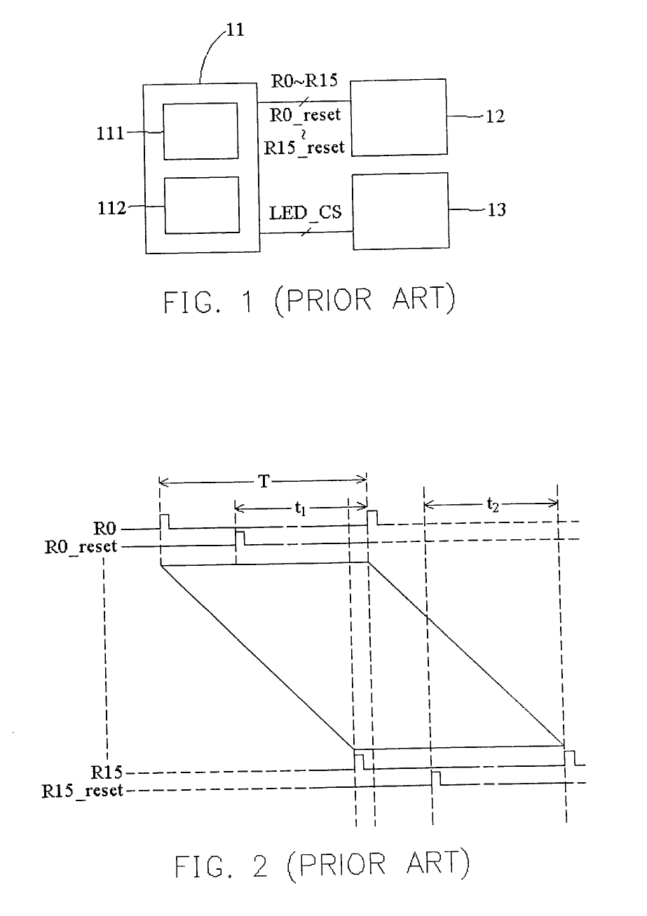

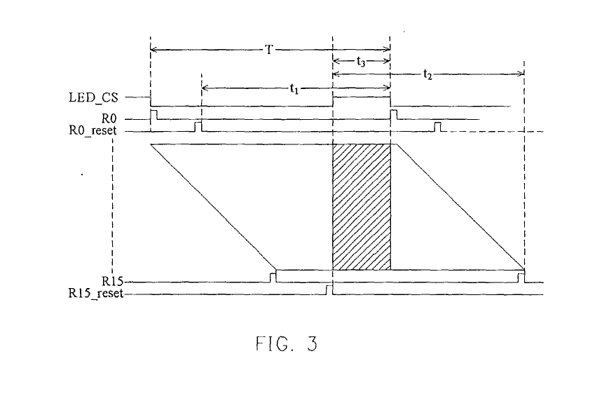

In the embodiment, since the block diagram of the image capture device is the same as that of the conventional image capture device, it is explained in the following by FIG. 3 accompanied with FIG. 1.

As shown in FIG. 1, the image capture device includes an exposure controller 11, a sensor array 12 and a light source 13. The exposure controller 11 has a column counter 111 and a line counter 112. The sensor array 12 is composed of lines and columns of pixels (not shown). The pixels accumulate charges therein when being exposed. The light source 13 illuminates a target image, whereby the image is reflected to the sensor array 12.

The operation of the image capture device is explained in the following. The sensor array 12 has, for example, 16 pixel lines 0˜15. The exposure controller 11 sequentially outputs readout signals R0˜R15 and reset signals R0_reset˜R15_reset to the sensor array 12. The charges previously accumulated in the pixels of a line to which a logic-high reset signal is applied are released, whereby the reset pixel line is refreshed to accumulate charges for the next frame. The voltages formed by the accumulated charges in the pixels of a line to which a logic-high readout signal is applied are output as pixel data. Thus, all the pixel data of each frame is progressively acquired line by line.

FIG. 3 is a diagram showing the timing of the readout and reset signals. The reset signals R0_reset is pulled up to a logic high level to reset the pixels of line 0 in the sensor array 12 and the readout signal R0 is also pulled up to the logic high level to read out the data in pixel line 0 after it has been exposed for one exposure time t1. Following the reset of pixel line 0, the reset signal R1_reset is pulled up to the logic high level to reset the pixels of line 1 and the readout signal R1 is also pulled up to the logic high level to read out the data in pixel line 1 after it has been exposed for one exposure time t1. The pixels and data of lines 2˜15 are reset and read out in the same way. The pulling up of the reset signals R0_reset˜R15_reset (i.e., the reset of pixel line 0˜15) follows the counting of line counter 112 and the lengths of the time intervals therebetween are the same.

The frequency of the pulses generated in each readout signals is the frame rate and the period T between the pulses is the frame time. The frame rate or time is controlled by line counter 112 in the exposure controller 11. Line counter 112 counts from an initial value (0) to a final value (31) larger than the number (16) of pixel lines. When the counting reaches the final value, it is reset to the initial value. The frame time is one cycle time of the counting.

It is noted from FIG. 3 that the cycle time (T) of line counter 112 is twice as long as the time (½T) needed for scanning from pixel line 0 to 15. More specifically, after pixel line 15 is reset, the sensor array 12 waits a half of the cycle time for line counter 112 to reach the final value. Pixel line 0 is not reset until line counter 112 is reset. This is different from the conventional image capture device wherein the first pixel line is reset immediately after the reset of the last pixel line. Pixel lines only follow the counting of line counter 112 to be reset during the first half of the cycle time but no pixel line does during the second half of the cycle time. This makes it possible for the exposure of pixel line 15 to begin prior to the end of the exposure of pixel line 0. That is to say, the exposure period t1 of pixel line 0 may overlap with the exposure period t2 of pixel line 15 in the overlapping interval t3. The overlapping interval t3 equals the difference of t1 and ½T.

In order to have the pixel data mainly acquired during the overlapping interval t3, the exposure controller 11 further controls the light source 13 so that the light source 13 is turned on only during the overlapping interval t3 and turned off beyond the interval t3. The corresponding control signal LED_CS is shown in FIG. 3. Thus, for a wireless optical mouse, the image capture device in this embodiment not only eliminates the image distortion resulting from a low frame rate but also saves battery power.

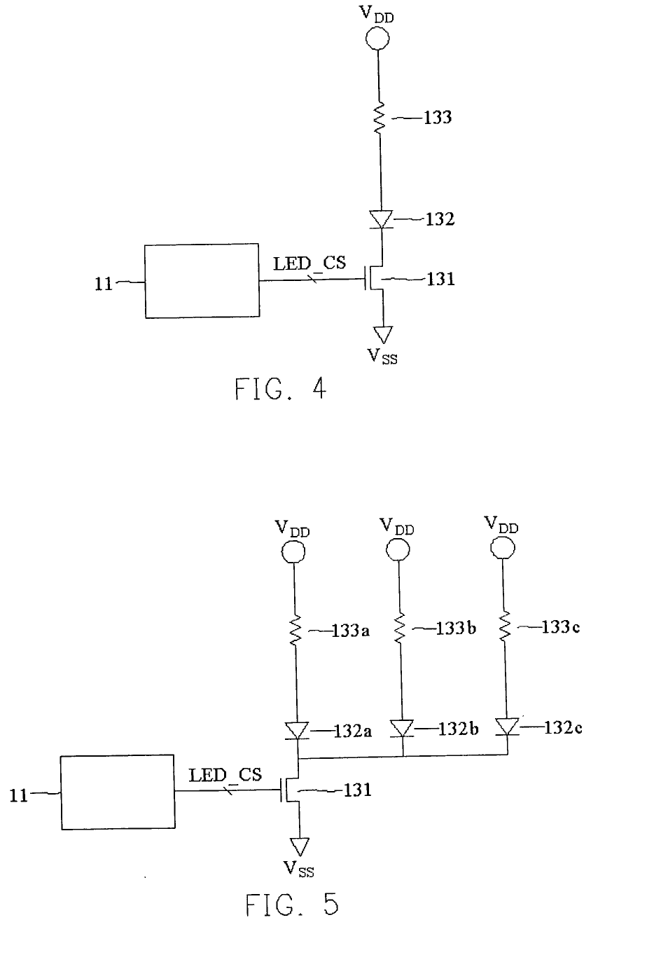

FIGS. 4 and 5 are diagrams showing two alternative light sources used in the image capture device according to the previously described embodiment of the invention. In FIG. 4, the light source 13 includes a transistor 131 used as a switch, an LED (light emitting diode) 132 and a resistor 133. The transistor 131 has the gate connected to the exposure controller 11 to receive the signal LED_CS, the source connected to the cathode of the LED 132 and the drain grounded. The resistor 133 is connected between a power supply VDD and the anode of the LED 132. Comparing to the light source in FIG. 4, the light source 13 in FIG. 5 further includes three LEDs 132a, 132b and 132c, three resistors 133a, 133b and 133c. The LEDs 132a, 132b and 132c are commonly connected to the source of the transistor 131. The resistors 133a, 133b and 133c are connected between the LEDs 132a, 132b and 132c, and the power supply VDD.

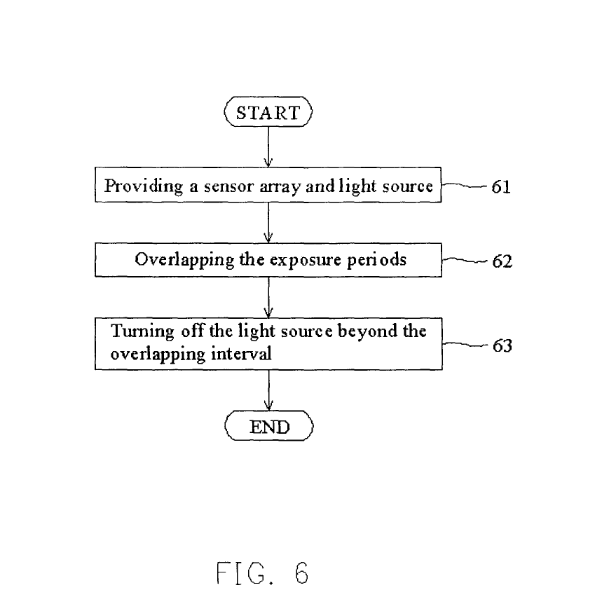

FIG. 6 is a diagram showing a method for image capture according to one embodiment of the invention.

In step 61, a sensor array and light source are provided. The sensor array has lines and columns of pixels.

In step 62, pixel lines are sequentially reset for exposure by reflection from the image for a period of time, wherein all the exposure time periods of pixel lines overlap.

In step 63, the light source is turned on only during the overlapping interval of the exposure time periods of pixel lines to illuminate the image, whereby the image is reflected to the sensor, and turned off beyond the overlapping interval.

In conclusion, the present invention provides an apparatus and method for simultaneously acquiring all pixel data of an image using a progressive scan sensor. Line counter counts to a number larger than the number of pixel lines, whereby the cycle time of the counter is prolonged. Instead of being reset immediately after the reset of the last pixel line, the first pixel line is not reset until the counter is reset. That is to say, after the last pixel line is reset, the counter keeps counting but no pixel line follows the counting to be reset until it reaches the final value. This eliminates the limitation in the conventional image capture device in which the exposure periods of the first and last pixel lines do not overlap.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. An apparatus for capturing an image to generate pixel data thereof, the apparatus comprising:
a sensor having pixel lines sequentially reset to be exposed by reflection from the image for a period of time, wherein all the exposure time periods of the pixel lines overlap;
a light source illuminating the image, whereby the image is reflected to the sensor; and
a controller turning on the light source during the overlapping interval of the exposure time periods of the pixel lines.

2. The apparatus as claimed in claim 1, wherein the controller comprises a counter by which the sensor follows to sequentially reset the pixel lines.

3. The apparatus as claimed in claim 2, wherein the counter is reset when reaching a final value and the final value is larger than the number of pixel lines, whereby the exposure time periods of the pixel lines overlap.

4. The apparatus as claimed in claim 1, wherein the controller turns off the light source beyond the overlapping interval.

5. The apparatus as claimed in claim 1, wherein the light source comprises:
a light emitting diode;
a resistor connected between a power supply and an anode of the light emitting diode; and
a switch connected between a ground and a cathode of the light emitting diode, and controlled by the controller.

6. The apparatus as claimed in claim 5, wherein the switch is a transistor having a gate connected to the controller, a drain connected to the ground and a source connected to the cathode of the light emitting diode.

7. A method for capturing an image to generate pixel data thereof, the method comprising the steps of:
providing a light source and a sensor having pixel lines;
sequentially resetting the pixel lines for exposure by reflection from the image for a period of time, wherein all the exposure time periods of the pixel lines overlap; and
turning on the light source during the overlapping interval of the exposure time periods of the pixel lines to illuminate the image, whereby the image is reflected to the sensor.
